(19) United States
(12) Patent Application Publication
(10) Pub. No.: US 2014/0149141 A1
(43) Pub. Date: May 29, 2014

(54) Remote Patient Monitoring System

(71) Applicant: Long Nguyen, Toronto (CA)

(72) Inventor: Long Nguyen, Toronto (CA)

(21) Appl. No.: 13/688,743

(22) Filed: Nov. 29, 2012

(51) Int. Cl. G06F 19/00

(52) U.S. Cl. CPC G06F 19/322
USPC 705/3

(57) ABSTRACT

A system for providing medical information to a plurality of users concerning a plurality of patients in a medical facility is disclosed. The system includes a first network at a medical facility having a first server and a medical database and a second network having a consent management database and a web server, the consent management database including a list of patients matched to a user list. A website on the web server enables users to input a request for medical information on patients. The web server is configured to forward the request for medical information to the first server. The first server is configured to extract medical information from the medical database about the patient identified in the request for medical information and forward same to the identified user's contact address upon receipt of the request for medical information.

### FIELD OF THE INVENTION

The invention relates generally to systems for remotely monitoring the condition of one or more patients in a medical facility.

### BACKGROUND OF THE INVENTION

We generally do not think about hospitals or other healthcare facilities until someone we know and love is sick and requires medical attention. Then our thoughts and focus are ever upon that person to whom our sympathy reaches out to. While frequent visitations are normal, the hours in between are fraught with anxiety and apprehension for our loved one. If there is a way to keep abreast of the patient's condition, that would certainly alleviate the stress and provide peace of mind.

It is possible to attempt to keep abreast of the patient's medical condition by calling the medical facility and talking to someone who is knowledgeable about the patient. However, most medical facilities will not divulge medical information concerning a patient even to a family member without the patient's prior consent. Furthermore, even if the patient has consented to the release of medical information to the family member calling the medical facility, it is quite likely that the medical facility has no means to keep track of which patients have granted consent and to whom and to what type of medical information. Finally, even if the medical facility is equipped to record which patients have granted consent and to whom, it is quite likely that the facility is only equipped to provide only the most basic and rudimentary information to the caller, such as the location of the patient within the facility. It is therefore desirable to provide a system of method for facilitating the authorized release of certain detailed medical information to family members and other users concerning patients.

### SUMMARY OF THE INVENTION

In accordance with one aspect of the present invention, there is provided a method for providing medical information to a plurality of users concerning a plurality of patients in a medical facility. The method includes the steps of providing a first network at the medical facility, the first network having a first server coupled to a medical database. The medical database has medical information on each of the patients in the medical facility. The method further includes the step of providing a second network remote from the first network, the second network having a consent management database coupled to a web server, the consent management database including a list of patients matched to a list of users who have been approved to receive medical information for the matched patients, the list of users including a contact address for each user. The method further includes the step of providing a website on the web server, said website enabling each user to input a request for medical information identifying one of the patients and the user requesting the medical information. The web server is configured to forward the request for medical information to the first server if the user identified in the request for medical information has been matched with the patient identified in the request for medical information in the consent management database. The first server is configured to extract medical information from the medical database about the patient identified in the request for medical information and forward same to the identified user's contact address upon receipt of the request for medical information.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of the system of the present invention illustrating the physical layout of the system.

FIG. 2 is a schematic view of the system of the present invention illustrating the logical layout of the system.

In the drawings like characters of reference indicate corresponding parts in the different figures.

### DETAILED DESCRIPTION OF THE INVENTION

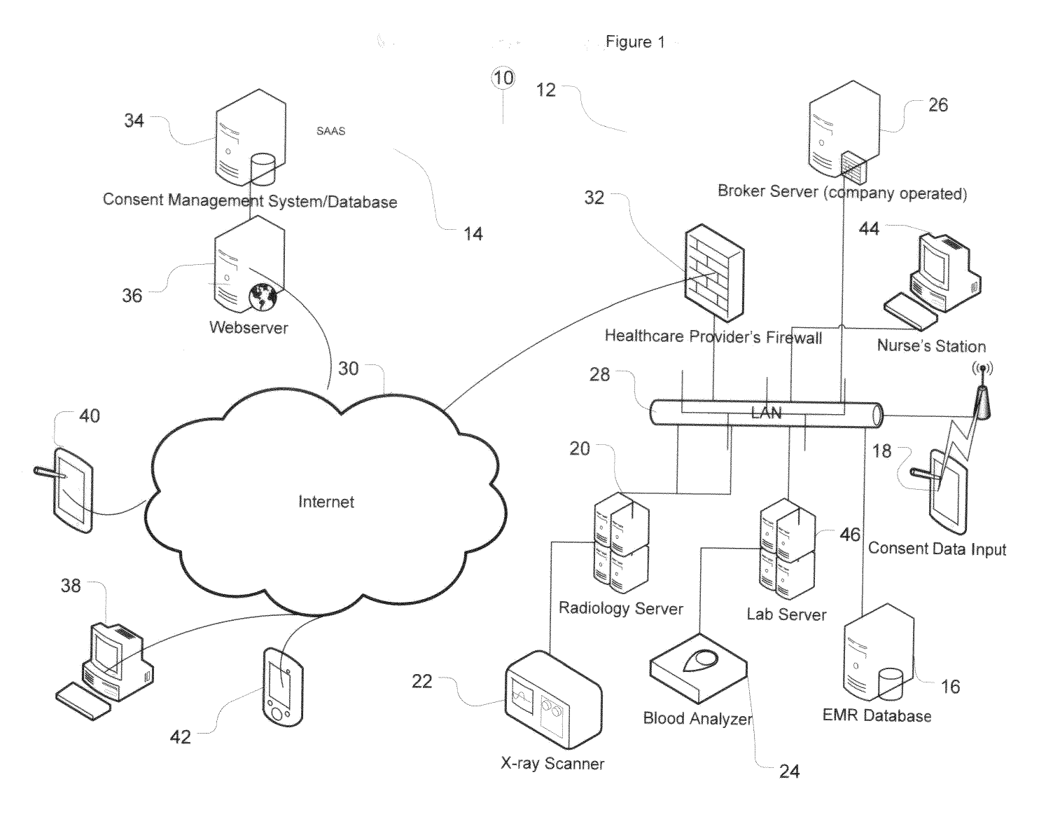

Referring firstly to FIG. 1, the system of the present invention, shown generally as item 10, includes a first network 12 physically located in a medical facility, and a second network 14 located remotely from the medical facility. Network 12 includes a medical database 16, one or more consent input devices 18, an application server 20 coupled to medical diagnostic equipment 22 and biometric reader 24 and a first server (broker server) 26 all of which are coupled to each other via LAN (local area network) 28. LAN 28 is coupled to internet 30 via firewall 32. Network 14 includes a consent management system database 34 and a webserver 36. Webserver 36 is coupled to internet 30, where a website (not shown) resident on server 36 can be accessed by users using computer 38, tablet computer 40 or mobile web enabled device 42.

Medical database 16 is a standard ODBC compliant database which organizes information about the patients in the medical facility. Database 16 will have at least one record per patient, with each record containing fields holding various information relating to the patient, both medical and non medical. For example, each record would likely have fields for storing the patient's name (or the name of the patient' guardian), the patient's unique identifier (patient number) used by the medical facility, the patient's medical insurance information, the patient's location within the medical facility, the patient's admitting diagnosis (e.g. admitted for abdominal pain), the patient's diagnosed condition (e.g. x-ray confirmed pelvic cancer), the patient's schedule for tests and diagnosis, the patient's results for previous tests and diagnosis, the patient's current prescription medication and the patient's current medical chart. Database 16 is coupled to inputs such as nurses stations 44, consent input devices 18 and diagnosis devices 22 and 24.

Consent input device 18 preferably consists of a tablet computer linked directly to the network via wireless networking Consent input device runs an application which is specifically designed to capture and record the patient's consent to release medical information. In particular, the consent application running on input device 18 will record the patient's insurance information, unique identifier, the name, addresses, phone numbers and email addresses of users whom are to be allowed access to the patient's medical records, what medical records (or medical information) is allowed to be viewed, how long the will the access be granted for, the patient's digital signature for the consent, and the name of the nurse or administrator who witnessed the signing of the consent. The information recorded in input device 18 is then uploaded to broker server 26 where it is stored. It is possible that the medical facility does not have wireless networking enabled, in which case input device 18 may consist of a wired computer terminal (such as nurses station 44) in combination with a paper form which is filled in by the patient or nurse/administrator.

Server 26 is the middleware between the medical database 16 and consent management server/database 34. It acts as a broker to pull information from the healthcare provider's database preferably via ODBC, or alternatively via HL7, and forward it to web server 36. It is physically located on the premises of the healthcare provider, and behind their firewall. It also stores input information from the consent input device. It also has a web portal for internal input from a nursing workstation (44) if no consent input device is available. Information stored on this server include: healthcare providers unique identifier (to identify the health care facility), the consenting patient's name and unique identifier, the patient's medical insurance information, the name, address and email of the user whom has been granted consent to access the patient's medical records (i.e. the grantee), criteria of information that is granted access to the grantee, start and expiration date of grantee access privileges, digital signature of patient or guardian, name of the witness to signature, logs of security access, logs of change access (including grantee addition/removal), patient's active status, grantee's active status. Server 26 consists of a database application, such as MySQL or the like, running in a suitable environment such as Linux with PHP, and hosting a HL7 integration tool.

Web server 36 is an internet portal hosted in the cloud. It connects to the consent management system database 34 to authenticate user identification and medical information access privileges. Upon successful user validation, it pulls from the broker server 26 the patient's record pointer based upon selected criteria granted to the grantee. The broker then pulls from the healthcare provider's database the current medical information based on criteria authorized to the grantee. No vital information of the patient is contained on this server; however, information on this server does include web and application interface for internet browsers, apple iStore and Android Market (eg. a web site), grantee's username and password management, printable or downloadable patient record information. Webserver 36 may be any commercially available webserver application running in any suitable environment, such as Apache running in a Linux environment with PHP and MySQL™. Database 34 may be running on the same computer as the webserver, or it may be on a different computer on the same network. Consent management server and database 34 couples directly to web server 36 and is also hosted on the cloud. This database is created from a standard database application such as MySQL™ operating on a suitable environment. The consent management database does not contain any patient names; however it does have patient's unique identifier, the healthcare provider's unique identifier, the grantee's unique username (can be email address) and password, criteria of information that is granted to the grantee, grantee's active status, patient's active status, start and expiration date of grantee access privileges, previous logons by grantee, attempts with failed logins, originating logon internet addresses, logs of security access. There is an index which matches (links) grantee's unique ID, the patient's unique ID and the healthcare providers (medical facilities) unique ID. This ensures that medical information does not inadvertently get sent to the wrong user/grantee.

As mentioned above, end users (grantees) whom have been granted access to a patient's medical records can access the patient's medical records using a variety of computing devices such as a computer 38, a tablet computer 40 or even a web enabled hand held device 42 such as an iPhone™ or Android™ phone. The device which the grantee uses is a computing device of some sort which is web enabled and capable of access a web site on web server 36. The computing device may access the web site via a web browser application, or alternatively, if the device is a iOS or Android type of device, the device may have an application which access the web site. The web site will display a form (in one way or another) where the user can request the medical information concerning a particular patient. The device connects to web server 36 via SSL only. The user enters his or her identification information in order to use web server 36 to forward a request for patient medical information.

The method of the present invention shall now be discussed with reference to the following example involving a hypothetical patient. The hypothetical patient, named John Smith felt abdominal pain several days before admitting himself into a hospital. He was sure the discomfort was only temporary and will soon pass. When the ache turned into agony, his wife urged him into emergency care. The following steps illustrate the process in which the remote patient monitoring system can increase efficiency of the healthcare process, empower the consumer with self-knowledge, and provide peace of mind to friends and family:

1. John Smith provides his name, Medicare ID (e.g. OHIP number), Insurance information, and other personal information relevant to the triage nurse. The nurse inputs John's information using the nurse's station computer 44 into the hosptial information system and issues John a hospital ID. This also records his information into the EMR database 16.

2. The ER doctor asks John a series of questions about his past medical conditions.

This data is also recorded into database 16.

3. The ER doctor then examines John and authorizes blood work to be performed, urine sample analysis, followed by X-ray scan of the abdomen area.

4. John's blood is drawn and brought to the laboratory to be tested, along with a sample of urine. The lab technician uses specific devices (like device 24) to perform the tests, with the results inputted into the application server 46.

5. John is brought into the X-ray room, where a technician runs the test using device 22, and the data collected is captured in the radiology server 20.

6. Since the hospital information system is networked (28) together, the data from servers 20 and 46 updates the EMR database 16.

7. The ER docotor reviews the test results, and relays his findings to John and his wife. He states that John has a kidney stone lodged in his left kidney, also known as renal calculus. The ER doctor then refers John to a nephrologist, who specializes in kidney pathology.

These findings are recorded in database 16.

8. According to the X-ray, the stone size is 2.2 cm, which is too large for the usual non-invasive procedure. Instead, the nephrologist recommends surgery, the procedure known as percutaneous nephrolithotomy. The doctor tells John all the facts about the procedure, including full anaesthesia, and that John will remain on premise post-op for about two to three days. John agrees to the procedure, and is moved to the surgery floor of the hospital to await an available surgeon. There, the floor nurse assigns him a room and gives him all customary courtesy, including a pamphlet for Patient Monitor since John will be resident for a few days. John didn't want or expect his wife to be by his side the entire duration, and knowing that she has to go to work, eagerly subscribes to the remote patient monitoring system.

9. The nurse opens up the Patient Monitor application and enters John's hospital ID into an Ipad™ tablet consent input device 18. The tablet application corresponds with the Broker server 26, which in turn verifies the patient ID with the EMR server 16. Once the ID has been confirmed, the tablet allows the nurse to continue with the consent management process. John reads the disclosure and liability form, and acknowledges that his wife, Jane Smith, and his family doctor will have full access to his medical records from the hospital for the entire duration of his ordeal. Part of the consent management system ID validation process includes a unique email address of the grantee. Jane Smith provided her email address as jsmith1234@gmail.com. Not knowing John's family doctor's email, Jane called the doctor and informed him of John's condition. The family doctor readily agrees to be kept abreast of John's condition, and provides his email address. The nurse acknowledges and confirms John's consent by inputting her ID in this consent agreement process. Once submitted, the tablet 18 records all the consent information into broker server 26. The broker server 26 in turn duplicates this consent information to consent management server 34 via secure channel SSL. The data traverses through the hospital's firewall 32 onto the Internet 30, then into the web portal 36, and finally into consent management server 34 where it is stored. The data transferred from broker server 26 to consent management server 34 is not medical information but rather information relating to the patient's consent to the release of medical information.

10. John didn't have to wait too long before a surgeon became available for the operation. The entire procedure lasted an hour without complications. Notes were taken in the operating room and recorded into server 16.

11. By the end of the evening, John was back in the hospital assigned bed and resting. His wife Jane decided it was time to go home knowing that John was in good hands. Although at home, Jane was still concerned for John's welfare. She promptly checked her email on her home computer 38 and had received a message from server 34. The email had a link to web server 36. Jane clicked on the link to bring her to the Patient Monitor secured web portal ID confirmation webpage. There she registered and validated her ID, read the liability and waiver form, and created a uniquely strong password to allow her access to John's medical records at the hospital. This password is stored and encrypted in consent management server 34.

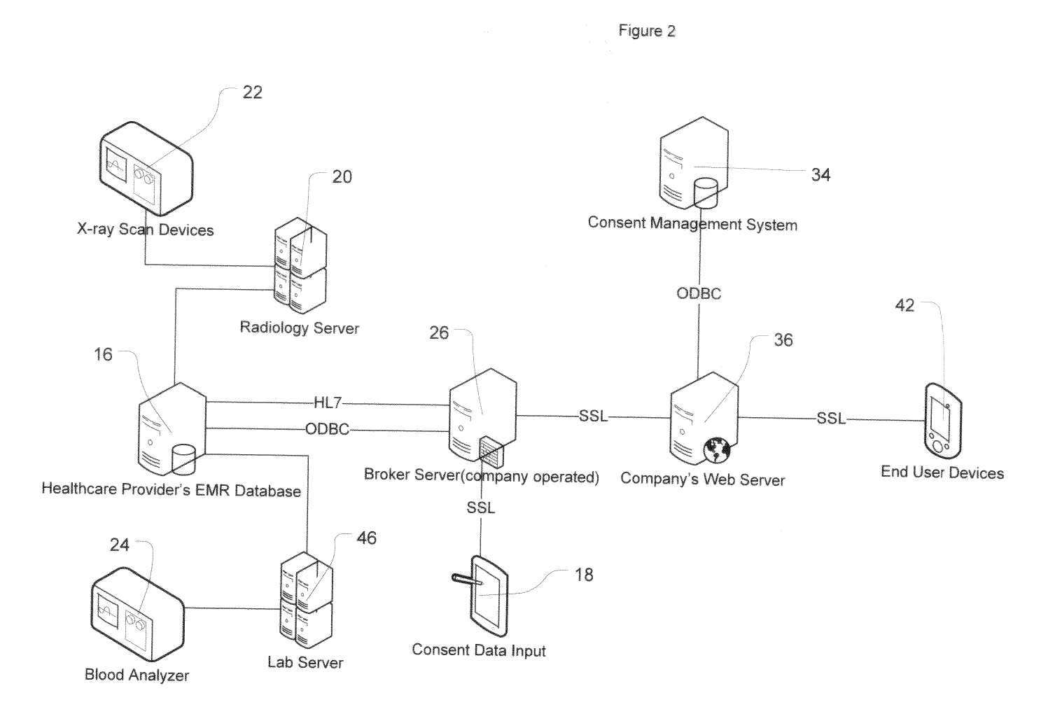

12. The next early morning Jane wanted to check on her husband's condition without calling the hospital directly. She clicked on a link using her computer 38 to the Patient Monitor login screen on web server 36, and enters her login and password. The web server 36 confirms ID and password validation with consent management server 34. Server 34 communicates and sends a request of the main page to broker server 25 via SSL. Server 26 relays the request to EMR server 16 via HL7 interpreter. Server 16 in this hospital is not ODBC compliant, but is programmed to accept HL7, acknowledges the request and transmits back to server 26 the request data. This data is transmitted using the secure socket layer (SSL) to web server 34, and finally onto originating requestor 38 following the logical diagram of FIG. 2.

13. The main page had information such as her husband's Admitting Diagnosis, Allergies, and Family Doctor name. Jane then navigates through the available screens showing her husband's medical information. At one point she clicked on the Radiology tab, and was shown an X-ray picutre of John's pelvic region. The picture clearly shows an object she recognized as the kidney stone. Other available tabs are Bloodwork, Microbiology, Past Records, Operating Room (OR) Notes, Reports, and Consultations. She clicked on Microbiology tab, where it shows her that another urine sample to be analyzed is “Pending”. The Bloodwork tab shows her that blood analysis is Normal, and that another sample diagnosis is “Pending”. She checked on the Reports tab, where a nurse's log stated John's anaesthesia effect had worn off and morphine drip was administered to alleviate pain during the night. Another tab indicated that the kidney stone was calcium in composition, based on lab analysis. The OR Notes stated that procedure percutaneous nephrolithotomy was performed without complications. She recalled the surgeon saying something familiar and wanted to know exactly what that entails. She copied the term onto a medical reference website such as the US National Institute of Health's MedlinePlus. It explains to Jane in detail about the surgical operation carried out if kidney stones are large or irregular. Every tab that Jane clicks on follows the same data transmission in step 12.

14. Jane's browsing session time from beginning to end was recorded in the consent management server 34, along with what informational tab was requested. The purpose of this log is useful for auditing requirements.

15. Jane then decides to go to work for a short while before visiting John at the hospital. During that time, she downloaded the Patient Monitor application onto her iphone™ device 42. She opens up the application and logs into web server 36 using the same process in step 12. The only update she found was that blood analysis was “Complete”. She looks forward to seeing her husband at the hospital soon.

16. John's family doctor receives a similar email to Jane Smith. He goes through the same validation process and accesses all relevant medical information as in steps 12 and 13. The doctor decides to copy pertinent information for John Smith's clinical file. One such vital data is the X-ray picture. The Radiology tab has a button to save the picture onto the doctor's computer. This record keeping ability allows John's primary care giver to be updated and better service him in the future.

The present invention has several advantages. Firstly, it provides a convenient means to allow loved ones and family members to quickly check on the status of a patient without having to visit the hospital or even call the hospital. The systems also allows a means for providing medical information to a

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A method for providing medical information to a plurality of users concerning a plurality of patients in a medical facility, the system comprising:
a. Providing a first network at the medical facility, the first network having a first server coupled to a medical database, the medical database having medical information on each of the patients in the medical facility;
b. Providing a second network remote from the first network, the second network having a consent management database coupled to a web server, the consent management database including a list of patients matched to a list of users who have been approved to receive medical information for the matched patients, the list of users including a contact address for each user;
c. Providing a website on the web server, said website enabling each user to input a request for medical information identifying one of the patients and the user requesting the medical information;
d. The web server configured to forward the request for medical information to the first server if the user identified in the request for medical information has been matched with the patient identified in the request for medical information in the consent management database;
e. The first server configured to extract medical information from the medical database about the patient identified in the request for medical information and forward same to the identified user's contact address upon receipt of the request for medical information.

2. The method of claim 1 wherein the first network includes at least one consent input device, the consent input device configured to record the patient's consent to grant one of the users access to the patient's medical information, the consent input device being coupled to the first server, the first server being configured to forward the recorded patient's consent to the consent management database of the second network.

3. The method of claim 2 wherein the first network includes a broker database coupled to the first server and the consent input device, the broker database including a record for each patient who has granted consent to the patient's medical information, each record containing a plurality of fields for identifying the patient, the user whom has been granted access, the medical information which is to be accessed and a time duration for accessing said medical information.

4. The method of claim 1 wherein the first server is configured to forward the medical information extracted from the medical database relating to the identified patient by routing the medical information through the web server of the second network without keeping a copy of the medical information in the second network.
